(19) United States
(12) Patent Application Publication
(10) Pub. No.: US 2010/0182801 A1
(43) Pub. Date: Jul. 22, 2010

(54) PRINTED ULTRA THIN LIGHT GUIDING PLATE

(75) Inventor: Yi-Ren Ye, Guangdong (CN)

Correspondence Address: Dr. BANGER SHIA;Patent Office of Bang Shia, 102 Lindencrest Ct., Sugar Land, TX, 77479-5201, US

(73) Assignees: DONGGUAN MEMTECH ELECTRONIC MEMTECH ELECTRONIC PRO, Guangdong (CN); MEMTECH INTERNATIONAL LTD, Singapore (SG)

(21) Appl. No.: 12/664,101

(22) PCT Filed: Jul. 4, 2007
(86) PCT No.: PCT/CN2007/002072

§ 371 Date: Dec. 11, 2009

(51) Int. Cl. F21V 7/04; G02B 27/10

(52) U.S. Cl. 362/623; 359/627

(57) ABSTRACT

A printed ultra thin light guiding plate comprises a plastic cement plate (1) with high transmissivity. On at least a surface of the upper and lower surfaces of the plastic cement plate are provided with a plurality of printed ink layers (12) in an array for forming refractive and reflective units. On each printed ink layer (12) is covered correspondingly with a printed ink layer (13) which is optical curable and comprises nanometer material.

### BACKGROUND OF THE INVENTION

1. Field of the Invention

The present invention relates to a light guiding plate for a backlight system, and more particularly to an ink-printed ultra thin light guiding plate.

2. Description of the Prior Art

As the technology for electronic/communication products such as cellular phones, household appliances, or the like, changes with each passing day, light guiding plates have been widely applied in liquid crystal displays (LCD) for various electronic/communication products. Light is generated by a backlight system (such as a cold cathode tube or light-emitting diodes) inside a liquid crystal display, and passes through the light guiding plate to guide the emerging light therefrom.

In general, manufacturing processes for backlight panels include two types: the printed type process and the non-printed type process. In the non-printed type process, a backlight panel is directly molded by a mold or pressed to form a light guiding pattern thereon. However, such technique has no relation to the present invention and will be explained in no more detail. As to the technique for a printed backlight panel, in an ink-printed light guiding plate that was disclosed in Chinese patent number ZL03240962.1, ink is printed on at least a surface of the upper and lower surfaces of the light guiding plate to form refractive and reflective units which as a whole are disposed in an array. Light is absorbed by the printed ink and then refracted and reflected to diffuse outwards. The chaotic scattering of light cannot ensure the uniformity of light emission, and the transmittance of a current ink-printed light guiding plate has not been improved correspondingly. Therefore, it is particularly important that how manufactures improve the transmittance of a light guiding plate and ensure uniform light emission for the sake of the development of future light guiding plates.

### SUMMARY OF THE INVENTION

The present invention has been made in consideration of the above-mentioned deficiencies existing in the current technologies, and has a primary object to provide a printed ultra thin light guiding plate which emits light uniformly.

Another object of the present invention is to provide a printed ultra thin light guiding plate with high transmissivity.

The foregoing objects of the present invention are achieved by the following technical solution:

A printed ultra thin light guiding plate comprising a plastic cement plate with high transmissivity, on at least a surface of the upper and lower surfaces of the plastic cement plate being provided with a plurality of printed ink layers in an array for forming refractive and reflective units, and on each printed ink layer being covered correspondingly with a printed ink layer which is optical curable and comprises nanometer material.

The printed ink layers are disposed gradually densely along the direction from the side of the plastic cement plate near an incident light source to the side of the plastic cement plate away from the incident light source.

An orthogonal projection of each printed ink layer on the surface of the plastic cement plate is square shaped, rectangular, circular arc shaped or polygonal.

A polygonal notch for improving the transmittance is at least provided at the side end of the plastic cement plate near the incident light source.

Compared to the current technologies, the present invention has the following advantages:

1. On the printed ink layer of each current refractive and reflective unit is further covered with another printed ink layer having a uniform light emission function which is optical curable and comprises nanometer material, so as to achieve the effect of uniform light emission of the light guiding plate and avoid the phenomenon of random light scattering.

2. It is convenient to use the combination of two printed ink layers for color modulation, wherein one layer is colorless and the other layer is colored.

3. The inner wall of the notch provided at the side end of the plastic cement plate near the incident light source can effectively increase the cross-sectional area for light entrance, so as to achieve the goal of high transmittance.

4. It is widely applied to liquid crystal displays for electronic/communication products such as cellular phones, household appliances, or the like.

### BRIEF DESCRIPTION OF THE DRAWINGS

FIG. 1 is a front planar schematic view of a structure of the present invention.

FIG. 2 is a cross-sectional schematic view of a structure of the present invention.

### DETAILED DESCRIPTION OF THE PREFERRED EMBODIMENTS

The present invention will be further described by way of examples in conjunction with the accompanying drawings.

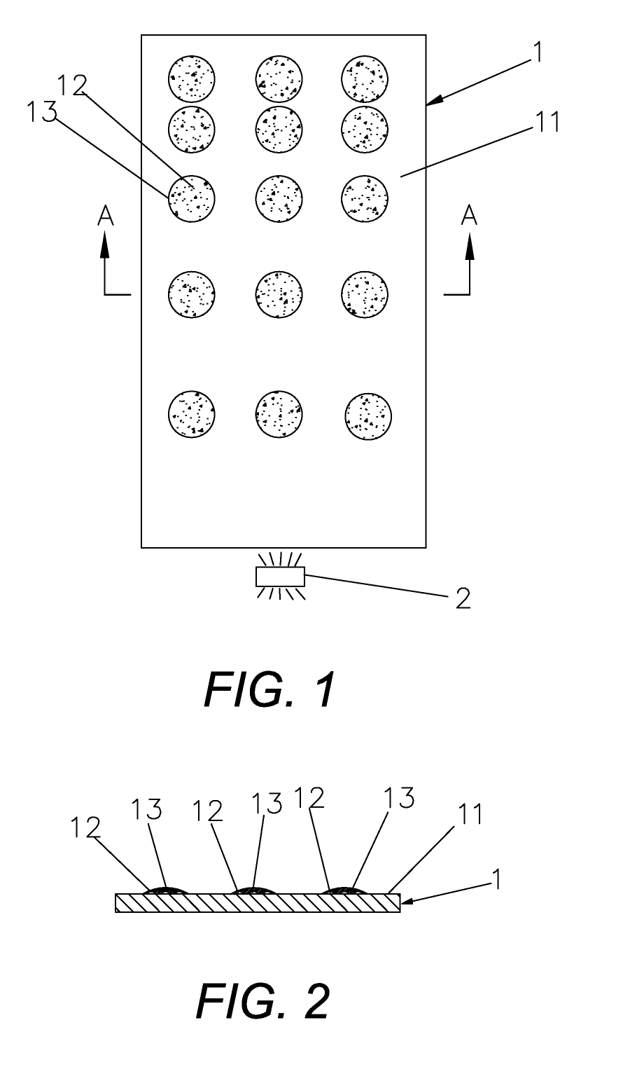

Referring to FIGS. 1 and 2, a printed ultra thin light guiding plate comprises a transparent plastic cement plate 1 with high transmissivity.

On the upper surface 11 of the plastic cement plate 1 are provided with a plurality of colorless printed ink layers 12 in an array for forming refractive and reflective units which are manufactured using light-scattering ink formed of nanometer material containing microparticles through silk screen printing or transfer printing. The printed ink layers 12 are disposed gradually densely along the direction from the side of the plastic cement plate 1 near an incident light source 2 to the side of the plastic cement plate 1 away from the incident light source 2. On each printed ink layer 12 is covered correspondingly with a colored printed ink layer 13 which is optical curable and comprises nanometer material. The colored printed ink layer 13 has a uniform light emission function, and similarly can be manufactured through silk screen printing or transfer printing. An orthogonal projection of each printed ink layer 13 on the surface of the plastic cement plate 1 is square shaped, rectangular, circular arc shaped or polygonal (in this embodiment, the orthogonal projection is circular arc shaped).

Of course, for the sake of further improving the transmittance, a polygonal notch may at least be provided at the side end of the plastic cement plate 1 near the incident light source 2 to increase the cross-sectional area for light entrance.

The critical design point of the present invention is that on the printed ink layer of each current refractive and reflective unit is further covered with another printed ink layer which is optical curable and comprises nanometer material, so as to achieve the effect of uniform light emission of the light guiding plate and avoid the phenomenon of random light scattering.

The above is only a preferred embodiment of the printed ultra thin light guiding plate of the present invention, but not to limit the technical solution of the present invention. Any slight alterations, equivalent changes and modifications to the above embodiment based on the technical substance of the present invention shall fall within the scope of the technical solution of the present invention.

What is claimed is:

1. A printed ultra thin light guiding plate, comprising a plastic cement plate with high transmissivity, on at least a surface of the upper and lower surfaces of the plastic cement plate being provided with a plurality of printed ink layers in an array for forming refractive and reflective units, wherein on each printed ink layer is covered correspondingly with a printed ink layer which is optical curable and comprises nanometer material.

2. The printed ultra thin light guiding plate as claimed in claim 1, wherein the printed ink layers are disposed gradually densely along the direction from the side of the plastic cement plate near an incident light source to the side of the plastic cement plate away from the incident light source.

3. The printed ultra thin light guiding plate as claimed in claim 2, wherein a polygonal notch is at least provided at the side end of the plastic cement plate near the incident light source.

4. The printed ultra thin light guiding plate as claimed in claim 1, wherein an orthogonal projection of each printed ink layer on the surface of the plastic cement plate is square shaped, rectangular, circular arc shaped or polygonal.
